(19) United States
(12) Patent Application Publication
(10) Pub. No.: US 2026/0342255 A1
(43) Pub. Date: Oct. 29, 2026

(54) METHODS AND SYSTEMS FOR CONTROLLING MULTIPHASE ELECTRICAL MACHINES

(71) Applicant: Ohio State Innovation Foundation, Columbus, OH (US)

(72) Inventors: Athar HANIF, Columbus, OH (US); Qadeer AHMED, Plain City, OH (US)

(21) Appl. No.: 19/106,346

(22) PCT Filed: Aug. 24, 2023
(86) PCT No.: PCT/US2023/031027

§ 371 Date: Feb. 25, 2025

Related U.S. Application Data
(60) Provisional application No. 63/373,624, filed on Aug. 26, 2022.

(51) Int. Cl. H02P 21/22; H02P 21/14; H02P 21/20

(52) U.S. Cl. CPC H02P 21/22; H02P 21/141; H02P 21/20; H02P 2205/01

(57) ABSTRACT

A method for controlling a multiphase electric machine is described herein. The method includes providing a control system operably connected to the multiphase electric machine; receiving, using the control system, a plurality of inputs, where the plurality of inputs represent the state of the multiphase electric machine; performing, using the control system, a linear parameters varying (LPV) based field oriented control (FOC) based on the plurality of inputs to generate one or more control signals; and controlling, using the control system, the multiphase electrical machine based on the one more control signals.

### CROSS-REFERENCE TO RELATED APPLICATIONS

This application claims the benefit of U.S. provisional patent application No. 63/373,624 filed on Aug. 26, 2022, and titled “METHODS AND SYSTEMS FOR CONTROLLING MULTIPHASE ELECTRICAL MACHINES,” the disclosure of which is expressly incorporated herein by reference in its entirety.

### BACKGROUND

Multiphase electrical machines (e.g., motors) can be used in electric vehicles. The control of multiphase electrical machines can depend on the load on the electrical machine. The load can cause phenomena such as torque derating in motors, which then can cause problems for accurate control of the machine. Additionally, aging and wear can also affect the control of multiphase electrical machines over time because aging and wear can affect the properties of the multiphase electrical machine that are modeled by a controller.

Therefore, what is needed are systems and methods of modeling and/or controlling multiphase electrical machines.

### SUMMARY

In some aspects, the techniques described herein relate to a method for controlling a multiphase electric machine, including: providing a control system operably connected to the multiphase electric machine; receiving, using the control system, a plurality of inputs, wherein the plurality of inputs represent a state of the multiphase electric machine; performing, using the control system, a linear parameter varying (LPV) based field oriented control (FOC) based on the plurality of inputs to generate one or more control signals; and controlling, using the control system, the multiphase electric machine based on the one or more control signals.

In some aspects, the techniques described herein relate to a method, wherein performing, using the control system, the LPV-based FOC includes estimating a thermally derated torque of the multiphase electric machine.

In some aspects, the techniques described herein relate to a method or claim 2, wherein performing, using the control system, the LPV-based FOC includes estimating a thermally derated flux of the multiphase electric machine.

In some aspects, the techniques described herein relate to a method, wherein the multiphase electric machine is a six-phase induction motor.

In some aspects, the techniques described herein relate to a method, wherein the control system includes: an outer control loop including flux and speed regulators, the outer control loop being configured to generate reference currents for the multiphase electric machine, and an inner control loop including a (d-q) currents controller, the inner control loop being configured to control and track reference frame (d-q) currents based on the reference currents generated by the outer control loop.

In some aspects, the techniques described herein relate to a method, further including determining a constant current for the multiphase electric machine using the outer control loop.

In some aspects, the techniques described herein relate to a method, wherein the outer control loop includes a speed regulator, and the method further includes determining a variable gain of the speed regulator.

In some aspects, the techniques described herein relate to a method, wherein the outer control loop includes a flux regulator, and the method further includes determining a variable gain of the flux regulator.

In some aspects, the techniques described herein relate to a method, wherein one or more control signals for controlling the multiphase electric machine include voltage signals.

In some aspects, the techniques described herein relate to a controller including: an outer control loop including a flux regulator and a speed regulator, the outer control loop being configured to: receive a plurality of inputs, wherein the plurality of inputs represent a state of a multiphase electric machine, and generate a plurality of reference currents for the multiphase electric machine; and an inner control loop including a (d-q) currents controller, the inner control loop being configured to: control and track reference frame (d-q) currents based on the reference currents generated by the outer control loop, and generate a feedback signal based on the reference frame (d-q) currents, wherein the outer control loop is further configured to receive the feedback signal generated by the inner control loop and generate one or more control signals for controlling the multiphase electric machine.

In some aspects, the techniques described herein relate to a controller, wherein the outer loop further includes an optimal flux controller.

In some aspects, the techniques described herein relate to a controller or claim 11, wherein the outer control loop further includes a variable-gain speed regulator.

In some aspects, the techniques described herein relate to a controller, wherein the outer control loop further includes a variable-gain flux regulator.

In some aspects, the techniques described herein relate to a controller, wherein the inner control loop is configured to maintain a constant current input to the multiphase electric machine.

In some aspects, the techniques described herein relate to a controller, wherein the one or more control signals include voltage signals.

In some aspects, the techniques described herein relate to a system including: a multiphase electric machine; and a controller operably coupled to the multiphase electric machine, the controller being configured to control the multiphase electrical machine, the controller including: an outer control loop including a flux regulator and a speed regulator, the outer control loop being configured to: receive a plurality of inputs, wherein the plurality of inputs represent a state of the multiphase electric machine, and generate a plurality of reference currents for the multiphase electric machine; and an inner control loop including a (d-q) currents controller, the inner control loop being configured to: control and track reference frame (d-q) currents based on the reference currents generated by the outer control loop, and generate a feedback signal based on the reference frame (d-q) currents, wherein the outer control loop is further configured to receive the feedback signal generated by the inner control loop and generate one or more control signals for controlling the multiphase electric machine.

In some aspects, the techniques described herein relate to a system, wherein the outer control loop further includes an optimal flux controller.

In some aspects, the techniques described herein relate to a system, wherein the outer control loop further includes a variable-gain speed regulator.

In some aspects, the techniques described herein relate to a system, wherein the outer control loop further includes a variable-gain flux regulator.

In some aspects, the techniques described herein relate to a system, wherein the inner control loop is configured to maintain a constant current input to the multiphase electric machine.

In some aspects, the techniques described herein relate to a system, wherein the multiphase electric machine is a multiphase induction motor.

In some aspects, the techniques described herein relate to a system, wherein the one or more control signals for controlling the multiphase electric machine include voltage signals.

In some aspects, the techniques described herein relate to a system, wherein the multiphase electric machine is a six-phase induction motor.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates a controller for a multiphase electrical machine, according to implementations of the present disclosure.

FIG. 1B illustrates a system including a controller and a multiphase electrical machine, according to implementations of the present disclosure.

FIG. 2 illustrates a method for controlling a multiphase electrical machine, according to implementations of the present disclosure.

FIG. 3 is an example computing device.

FIG. 4 illustrates an example architecture of a six-phase traction induction machine fed by a voltage source inverter, according to implementations of the present disclosure.

FIG. 5 illustrates an operating temperature profile of a high-power induction machine, according to an implementation of the present disclosure.

FIG. 6 illustrates vehicle speed tracking including a performance comparison of conventional indirect field-oriented control and an LPV-based indirect field-oriented control scheme according to an implementation of the present disclosure.

FIG. 7 illustrates six-phase induction machine flux tracking for a conventional indirect field-oriented control scheme compared to an LPV-based indirect field-oriented control scheme according to an implementation of the present disclosure.

FIG. 8 illustrates vehicle torque tracking for a conventional indirect field-oriented control scheme compared to an LPV-based indirect field-oriented control scheme according to an implementation of the present disclosure.

FIG. 9 illustrates example specifications of a passenger bus.

FIG. 10 illustrates example parameters of a six-phase induction machine.

FIG. 11 illustrates root-mean-square error performance indexes for the comparison of different control techniques, according to an example implementation of the present disclosure.

FIG. 12 illustrates a block diagram of a field-oriented control framework.

FIG. 13 illustrates a block diagram of an example implementation of the present disclosure compared to another control loop.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event, or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for controlling 6-phase electric motors, it will become evident to those skilled in the art that the implementations are not limited thereto, but are applicable for modeling and controlling electrical machines powered by any number of electrical phases.

Multiphase electric machines can include several advantages when used in the electric drive system of electric vehicles. The performance of an electric drive system in extreme working conditions can be extremely compromised. An electric drive suffers from torque derating, a decrease in efficiency, and an increase in loss of lifetime (aging) as its parameters change due to the rise in operating and ambient temperatures. A dynamic control scheme is described that facilitates the control of multiphase electric machines to overcome the problem of thermally derated torque, minimizing the loss of lifetime (aging) and to improve the energy conversion efficiency of multiphase electric machines. Dynamic control schemes allow the controller to schedule (re-compute) itself based on the changes observed in the parameters of the electric drive system to address the issue of thermally derated torque. It can use the machine's losses to compute the optimal flux demand to ensure the improvements in the energy conversion efficiency of the machine and develop a dynamic relationship between road load demands and flux. In this scheme, the optimal cost function is formulated based on the operating voltages and currents' constraints to minimize the aging. Non-limiting examples of applications where implementations of the present disclosure can be applied include: Electric passenger aircraft; spacecraft (e.g., NASA missions) can benefit for many applications such as reliable and efficient control algorithms for high power density motor; manufacturers seeking improved efficiency of their electric drive systems; and/or automotive industry applications (medium and heavy-duty trucks especially). Additional benefits of multiphase electric machine controls can include improving efficiency and/or performance, improving efficiency and/or performance during aging, reducing emissions, reducing losses, and smoothing torque commands.

Described herein are methods for controlling multiphase electrical machines. Methods described herein can include performing linear parameters varying (LPV) based field-oriented-control (FOC) on the plurality of inputs. The methods described herein can be used to estimate thermally derated torque and/or flux in an electrical machine, which can be used as an input for controlling the electrical machine.

Implementations of the present disclosure can be used to estimate the thermally derated torque of an electric drive system for an electrified vehicle. As a non-limiting example, the thermally derated torque can be particularly important when the electrified vehicle is operating in extreme or harsh conditions.

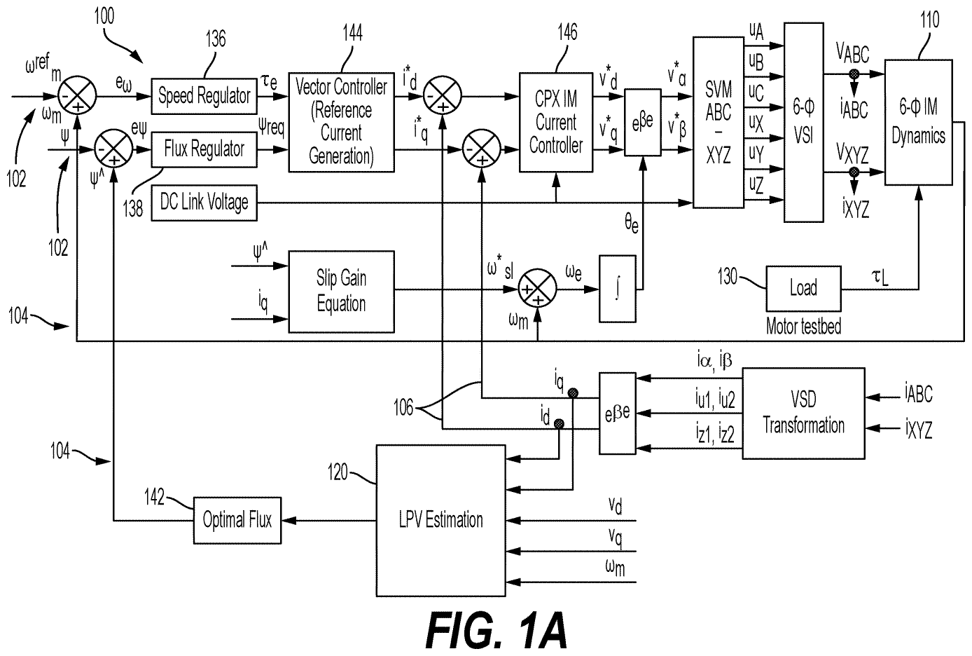

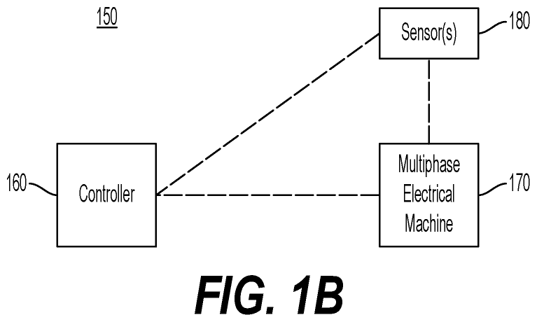

With reference to FIG. 1A, an example implementation of a controller 100 for a multiphase electrical machine is shown. The controller 100 can include one or more control loops. In the example, controller 100 shown in FIG. 1A, the controller 100 includes the outer control loop 104 and inner control loop 106.

The outer control loop 104 can include a flux regulator 138 and a speed regulator 136. The outer control loop 104 can be configured to receive one or more inputs 102 that represent measured and/or estimated inputs to the operating multiphase electrical machine. Non-limiting examples of inputs 102 to the controller 100 include rotational speed and flux. Non-limiting examples of states of the multiphase electric machine that can be inputs include the rotor speed (ωₘ) and the d-axis current (i_{d}) the q-axis current (i_{q}), the d-axis voltage (v_{d}) and the q-axis voltage (v_{q}). In some implementations, alternative or additional states that can be used to model the multiphase electric machine include the α-axis and β-axis stator currents, voltages, and fluxes: iαs, iβs, vαs, vβs and ψαs, ωβs. Alternatively or additionally, the states can include electrical rotor speed. Parameters that can be used to model the multiphase electrical machine include Lₛ, Lᵣ, and Lₘ that are the stator, rotor, and mutual inductance respectively. Non-limiting examples of additional parameters that can be used to model the multiphase electrical machine include Rₛ and Rᵣ are the stator and rotor resistances, τₑ is the electromagnetic generated torque, T is the load torque, P is the number of poles, J is the rotor inertia, and b is the viscous friction coefficient, respectively.

The outer control loop 104 can be further configured to generate reference currents (i*_{d} and i*_{q} in FIG. 1A). In some implementations, the outer control loop 104 includes a d-q currents controller 146. The reference currents are provided to the inner control loop 106 for further processing as described below. Optionally the reference currents (i*_{d} and i*_{q} in FIG. 1A) can be generated by a vector controller 144, as shown in FIG. 1A.

The inner control loop 106 can be configured to control and track the frame currents (i_{d} and i_{q} in FIG. 1A) based on the reference currents (i*_{d} and i*_{q} in FIG. 1A) generated by flux and speed controllers of the outer control loop 104. Additionally, the inner control loop 106 can generate a feedback signal based on the frame currents (i_{d} and i_{q}). For example, the inner control loop 106 includes an LPV estimator 120 that can estimate a feedback signal based, at least in part, on the frame currents (i_{d} and i_{q}). Feedback signal generation is discussed, for example, in detail in Example 1. Equations 21 and 22, described herein in example 1, can optionally be used to generate feedback signals, according to the example implementation of the present disclosure described in Example 1. The feedback signal can be provided to the outer control loop 104 of the controller 100.

The outer control loop 104 can be further configured to receive the feedback signal generated by the inner control loop 106 and generate one or more control signals for controlling the multiphase electric machine 110. Control signal generation is discussed, for example, in detail in Example 1. Equation 19 can optionally be used to generate feedback signals, according to the example implementation of the present disclosure described in Example 1. Optionally, the current the d-q currents controller 146 can be configured to generate the feedback signals. In some implementations, the one or more control signals can be voltage signals.

In some implementations, the inner control loop 106 can further include an optimal flux controller 142. As used herein, the term “optimal flux” refers to a flux command that obtains the maximum efficiency of an electric drive system based on the losses of the multiphase electrical machine. Alternatively, or additionally, the inner control loop 106 can be configured to maintain a constant current input to the multiphase electric machine.

In some implementations, the speed regulator 136 is a variable gain speed controller.

In some implementations, the flux regulator 138 is a variable-gain flux controller.

The controller 100 can output a prediction of the required voltages of the multiphase electrical machine that can be used to control the multiphase electrical machine. For example, the controller 100 can take the thermally detected torque and flux of the multiphase electrical machine and use this prediction to generate control signals. As a non-limiting example, the output of the controller 100 shown in FIG. 1A, can be used to control a six-phase induction machine under the presence of variable loads 130.

As a non-limiting example, the controller 100 can be used to control a six-phase induction motor. It should be understood that a six-phase induction motor is provided only as an example. This disclosure contemplates using the controller 100 described herein with other motors used in electric drive systems including, but not limited to, motors used in an electric drive passenger bus for urban transportation. The LPV FOC can estimate the thermally derated torque and flux of the six-phase electric motor(s) and the control of the six-phase electric motors can be based at least partially on the estimated thermally derated torque and flux.

With reference to FIG. 1B, a system 150 is shown according to an implementation of the present disclosure. The system 150 can include a multiphase electrical machine 170 and a controller 160. The controller 160 can be operably connected to the multiphase electrical machine 170. For example, the multiphase electrical machine 170 can include the multiphase machine 410 and/or voltage-source inverter 420 shown in FIG. 4. Optionally, the multiphase electric machine can be the multiphase electric machine fed by a voltage-source inverter.

The controller 160 can optionally include any of the components described with reference to the controller 100 of FIG. 1A. For example, the controller 160 can include the inner control loop 106, flux regulator 138, speed regulator 136, and/or outer control loop 104. Like the controller 100 shown in FIG. 1A, in various implementations of the present disclosure the controller 160 can also include an optimal flux controller 142, the speed regulator 136 in the controller 160 can optionally be a variable gain speed controller, and/or the flux controller in the controller 160 can optionally be a variable-gain flux controller.

The controller 160 can be configured to maintain required current to the multiphase electrical machine, for example an inner loop of the controller 160 (not shown) can be configured to maintain required current to the multiphase electrical machine 170.

In some implementations, the multiphase electrical machine 170 is a multiphase induction motor.

In some implementations, the controller 160 can be configured to output control signals to the multiphase electrical machine 170. Optionally, the control signals can include one or more voltage signals and/or current signals.

Optionally, the state of the multiphase electrical machine can be measured using one or more sensors 180 in communication with the controller 160. The one or more sensors 180 can include sensors to measure any/all of the following non-limiting examples of states of the multiphase electrical machine 170: ωₘ i_{d}, i_{q}, v_{d}, v_{q}, α-axis and β-axis stator currents, voltages, and fluxes (iαs, iβs, vαs, vβs and ψαs, ψβs). Parameters that can be used to model the multiphase electrical machine include Lₛ, Lᵣ and Lₘ, Rₛ, Rᵣ, τₑ, τ_{L}, P, J, and b.

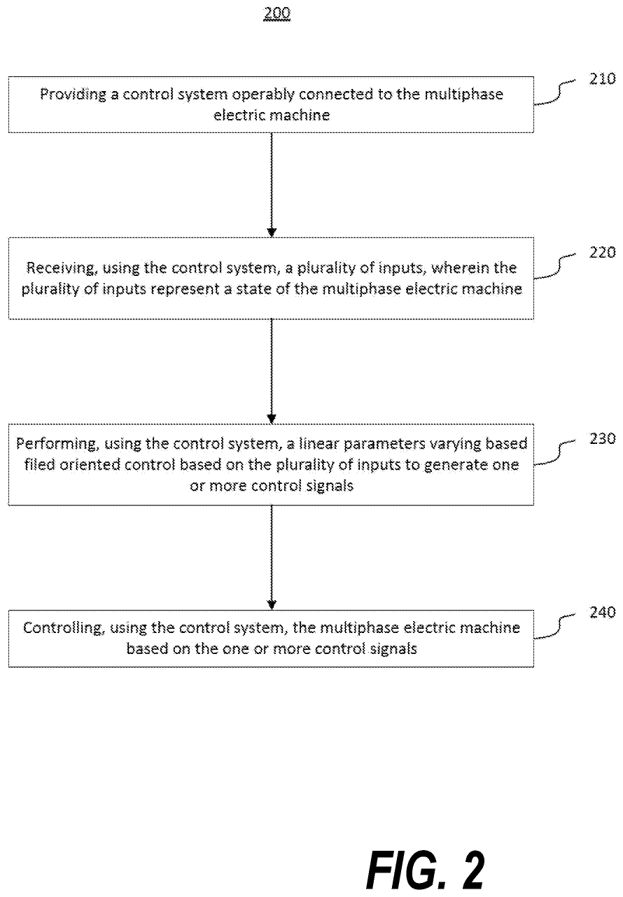

FIG. 2 illustrates a method 200 of controlling a multiphase electric machine, according to implementations of the present disclosure.

At step 210 the method 200 includes providing a control system operably connected to the multiphase electric machine. As non-limiting examples, the method 200 can be implemented by a controller or control system (e.g., the controller 100 shown in FIG. 1A) that is configured to control a multiphase electric machine. As another non-limiting example, the multiphase electric machine can be a six-phase induction motor.

As described with reference to FIG. 1A, in some implementations, the control system can include an outer control loop 104 including flux and speed controllers, the outer control loop 104 can be configured to generate reference currents (i*_{d} and i*_{q} in FIG. 1A) for the multiphase electric machine. Again, the reference currents can be provided to the inner control loop (e.g., inner control loop 106 in FIG. 1A) for further processing as described below. Alternatively or additionally, the control system can further include an inner control loop 106 including a (d-q) currents controller, the inner control loop 106 being configured to control and track frame currents (i_{d} and i_{q} in FIG. 1A) based on the reference currents (i*_{d} and i*_{q} in FIG. 1A) generated by the outer control loop (outer control loop 104 in FIG. 1A).

At step 220, the method 200 includes receiving, using the control system, one or more inputs, where the inputs represent the state of the multiphase electric machine. Non-limiting examples of states of the multiphase electric machine include the rotor speed (ωₘ) and the d-axis current (i_{d}) the q-axis current (i_{q}), the d-axis voltage (v_{d}), and the q-axis voltage (v_{q}). In some implementations, alternative or additional states that can be used to model the multiphase electric machine include the α-axis and β-axis stator currents, voltages, and fluxes: iαs, iβs, vαs, vβs and ψαs, ψβs. Alternatively or additionally, the states can include electrical rotor speed. Lₛ, Lᵣ and Lₘ are the stator, rotor and mutual inductance respectively. Rₛ and Rᵣ are the stator and rotor resistances, τₑ is the electromagnetic generated torque, τ_{L} is the load torque, P is the number of pole, J is the rotor inertia, b is the viscous friction coefficient, respectively.

At step 230, the method 200 includes performing, using the control system, a linear parameter varying (“LPV) based field oriented control (“FOC”) based on the inputs to generate one or more control signals. Additionally, the inner control loop (e.g., inner control loop 106 in FIG. 1A) can generate a feedback signal based on the frame) currents (i_{d} and i_{q})·=. For example, the inner control loop can include an LPV estimator (e.g., LPV estimator 120 in FIG. 1A) that can estimate a feedback signal (e.g., feedback signal in FIG. 1A) based, at least in part, on the frame currents (i_{d} and i_{q}). Optionally performing LPV-based FOC can include estimating a thermally derated torque of the multiphase electric machine. Alternatively or additionally, performing LPV-based FOC can include estimating a thermally derated flux of the multiphase electric machine.

At step 240, the method 200 includes controlling, using the control system, the multiphase electric machine based on the control signals. For example, the control can be performed using the control signals shown in FIG. 1A. In some implementations, the one or more control signals for controlling the multiphase electric machine can include voltage signals.

In some implementations, the method 200 can include determining a current reference for the multiphase electric machine using the outer control loop.

In some implementations, the outer control loop includes a speed controller and the method further includes determining a variable gain of the speed controller. Optionally, the outer control loop includes flux controller, and the method 200 can further include determining a variable gain of the flux controller.

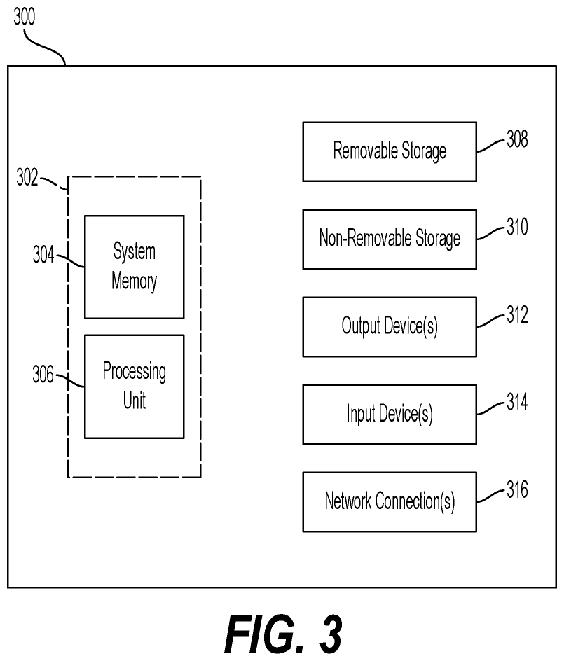

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by dashed line 302. The processing unit 306 may be a standard programmable processor that performs arithmetic and logic operations necessary for the operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate the communication of data among the components of the computing device 300. All these devices are well-known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example of tangible, computer-readable media may include, but is not limited to, volatile media, non-volatile media, removable media, and non-removable media implemented in any method or technology for storage of information such as computer-readable instructions, data structures, program modules, or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices, and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, the temperature is in °C or is at ambient temperature, and pressure is at or near atmospheric.

### Example 1

A study was conducted of an example implementation of the present disclosure that includes multiphase induction machine controllers configured for electric drive systems of electrified vehicles.

Multiphase induction machines possess several advantages compared to three-phase induction machines when used in the Electric Drive System (EDS) of Electrified Vehicles (EV). The performance of an EDS in extreme working conditions can be compromised. An electric drive suffers from torque derating as its parameters change due to the rise in operating and ambient temperatures. The performance of commonly used Field Oriented Control (FOC) in the EDS of EV is deteriorated under the vast variations in the rotor and stator resistances due to the change in the operating conditions. The example implementation of the present disclosure can use a robust Linear Parameters Varying (LPV) based FOC to estimate the thermally derated torque and flux to improve the performance of EDS when it operated in harsh environment. The performance of the example control technique is verified and investigated for the electric drive of a passenger bus (class-4) used in urban transportation. The Federal Urban Driving Schedule (FUDS) is adopted for the simulation experiment and validation of the proposed approach. The nonlinear simulation results show the capability of the proposed technique to accurately estimate and track the derated torque and flux demands in a six-phase Induction Machine (IM) based EDS.

In order to meet the energy demands and reduce the emissions to the environment, the automobile industry can use new technologies from electric ship propulsion, electric aircraft, hybrid, and electric on-road and off-road vehicles. In energy-efficient propulsion and traction applications, the Electric Machine (EM) is an integral part of the EDS. Hence, an EM has significant impact on the performance of the EDS for modern ground and aerial vehicles. In order to improve the performance of the EDS, major efforts are in the direction of the design and realization of closed loop controllers [1] and reasonable design of an EM [2]. Conventional, three-phase EM based solutions for the electrification of the above-mentioned applications, are not necessarily the optimum choices. Indeed, multiphase electric machines offer several potential benefits over three-phase counterparts. Two example advantages are: (i) due to the split of the power over more phases, power rating requirements of the power semiconductor devices on the converter can be reduced and (ii) regardless of the number of the phases, two independent controllable currents are required for flux and torque control [3]. Among the existing electric machines, induction machine offers the several advantages over the other types of electric machines [4]. Multiphase induction machines have the advantages of low pulsating torque due to the use of multi-step inverter, better reliability, ability to operate in case of open phase fault and smaller rated current per phase as compare to 3−φ induction machine with similar nominal power [5], [6].

In traction applications, a main objective for the efficient operation of EDS is to achieve precise and accurate tracking to meet the road load demands. A field-oriented Control (FOC) technique is used for torque and flux control of induction machine. The performance of the conventional FOC deteriorates due to the parameter variations during the operation. The IM parameters, rotor and stator resistance, vary due to operating conditions such as traffic situations, driving cycles and operating temperatures. Hence, flux and torque of an EDS derates. Therefore, to obtain the improved performance of EDS for above-mentioned systems, effective implementation of FOC for an EDS requires accurate and precise knowledge and control of thermally derated torque and flux.

Conventional indirect field-oriented control (IFOC) schemes exist [7] for the operation and control of multiphase induction machines. A control system for multiphase induction machine with the utilization of backstepping technique can improve the performance of the induction machine drive in the presence of uncertainties in plant model. [6] Sliding mode and fuzzy logic based controls for six-phase induction machine are an alternative [9]. Sliding-Mode Control (SMC) is robust against the uncertainties in the model parameters but it can suffer from the chattering problem. Hence, it can be difficult to ensure the accurate and precise performance of the EDS. To overcome the problem of chattering, LPV control techniques limited to three-phase induction machines are studied [1], [4], [10]. The main objective of an LPV control (gain scheduling) technique is to control the plant over a predefined operating range. However, it allows the controller to schedule itself based on some measurements in addition to robustness.

Optionally, a observer-controller scheme can be used to address the problem of thermally derated torque in EDS for the efficient and accurate operation of electrified vehicles. Various implementations of the present disclosure include combinations of:
(1) A robust observer controller pair based on LPV gain scheduling technique for the estimation and control of thermal flux and torque derating in EDS;
(2) Calculated optimal flux commands for the EDS using the knowledge of different losses in the EM to minimize the energy consumption;
(3) The study described herein was evaluated for six-phase induction machine based electrified powertrain under standard driving cycle.

The present example describes the architecture of the six-phase IM drive and modeling of IM. Variations in the operating temperature of high power IM are presented in Section III. Estimation of the thermally derated torque and flux are also presented with example design details of robust LPV based IFOC scheme. The proposed control scheme is validated.

FIG. 4 describes the architecture of six-phase traction IM which is fed by the six-phase open-end Voltage Source Inverter (VSI). The asymmetric architecture of six-phase traction IM is achieved by having the spatial displacement of 30° e between the two sets of 3−φ winding. This also gives the two isolated neutral points which ensure optimized utilization of V_{dc} link and eliminate zero sequence currents.

The Clark transformation matrix (Eq. 1) is adopted to construct the decoupled orthogonal subspaces (α-β, μ₁-μ₂, and z₁-z₂) from the normal six-phase system (a-b-c, x-y-z).

$${T}_{6} = \frac{1}{3} [ \begin{matrix}1 & cos ( ϕ ) & cos ( 4 ϕ ) & cos ( 5 ϕ ) & cos ( 8 ϕ ) & cos ( 9 ϕ ) \\ 0 & sin ( ϕ ) & sin ( 4 ϕ ) & sin ( 5 ϕ ) & sin ( 8 ϕ ) & sin ( 9 ϕ ) \\ 1 & cos ( 5 ϕ ) & cos ( 8 ϕ ) & cos ( ϕ ) & cos ( 4 ϕ ) & cos ( 9 ϕ ) \\ 0 & sin ( 5 ϕ ) & sin ( 8 ϕ ) & sin ( ϕ ) & sin ( 4 ϕ ) & sin ( 9 ϕ ) \\ 1 & 0 & 1 & 0 & 1 & 0 \\ 0 & 1 & 0 & 1 & 0 & 1\end{matrix} ] \qquad ( 1 )$$

The present disclosure can include a vehicle model. The vehicle speed (v_{w}) is proportional to the machine speed (ω). It can be defined in term of ratio of gear box (gᵢ), transmission gain (g_{d}) and radius of tire (Rₜ) and given as [11]:

$${v}_{w} = \frac{{R}_{t}}{{g}_{d} {g}_{i}} ω \qquad ( 2 )$$

The load torque (TL) of an EV can be written as:

τ_{L}=(F_{R}+F_{d}+F_{g}+Fₐ)Rₜ (3)
where, F_{R} is rolling resistance force, F_{d} is the drag force, F_{g} is grad resistance force and Fₐ is acceleration resistance force.

The mathematics of a six-phase IM in stationary reference frame can be expressed as follows, [8]:

The voltage equations for α-β reference frame are:

$$\{ \begin{matrix}{\dot{ψ}}_{α s} = {v}_{α s} - {R}_{s} {i}_{α s} \\ {\dot{ψ}}_{β s} = {v}_{β s} - {R}_{s} {i}_{β s} \\ 0 = {R}_{r} {i}_{α r} + {\dot{ψ}}_{α r} + {ω}_{r} {ψ}_{β r} \\ 0 = {R}_{r} {i}_{β r} + {\dot{ψ}}_{β r} - {ω}_{r} {ψ}_{α r}\end{matrix} \qquad ( 4 )$$

The voltage equations for μ1-μ2 reference frame are:

$$\{ \begin{matrix}{L}_{ls} {i}_{μ 1 s} = {v}_{μ1 s} - {R}_{s} {i}_{μ1 s} \\ {L}_{ls} {i}_{μ2 s} = {v}_{μ2 s} - {R}_{s} {i}_{μ2 s}\end{matrix} \qquad ( 5 )$$

The flux linkages equations are:

$$\{ \begin{matrix}{ψ}_{α s} = {L}_{s} {i}_{α s} + {L}_{m} {i}_{α r} \\ {ψ}_{β s} = {L}_{s} {i}_{β s} + {L}_{m} {i}_{β r} \\ {ψ}_{α r} = {L}_{m} {i}_{α s} + {L}_{r} {i}_{α r} \\ {ψ}_{β r} = {L}_{m} {i}_{β s} + {L}_{r} {i}_{β r}\end{matrix} \qquad ( 6 )$$

The electromagnetic torque equation is:

$$\{ \begin{matrix}{T}_{e} = ( \frac{3}{2} ) P ( {ψ}_{α s} {i}_{β s} - {ψ}_{β s} {i}_{α s} ) \\ ψ = \sqrt{{ψ}_{α s}^{2} + {ψ}_{β s}^{2}}\end{matrix} \qquad ( 7 )$$

and the speed dynamics

$${\dot{ω}}_{m} = ( \frac{P}{2 J} ) ( {T}_{e} - {T}_{L} - b {ω}_{m} ) \qquad ( 8 )$$

where i_{αs}, i_{βs}, v_{αs}, v_{βs} and ψ_{αs}, ψ_{βs} are the α-axis and β-axis stator currents, voltages and fluxes respectively. ωₘ is the electrical rotor speed. Lₛ, Lᵣ and Lₘ are the stator, rotor and mutual inductance respectively. Rₛ and Rᵣ are the stator and rotor resistances, τₑ is the electromagnetic generated torque, τ_{L} is the load torque, P is the number of pole, J is the rotor inertia, b is the viscous friction coefficient, respectively.

Implementations of the present disclosure include LPV modeling of six-phase induction machines. Since the flux and torque producing component in a six-phase induction machine are only the α-β components (d-q components in case of rotating reference frame). The description of the rotor flux and electromagnetic generated torque of an IM presented in Eqs. (4) and (7) are same as for 3-ψ IM. Hence, the FOC scheme for any number of phases on IM is similar to the conventional 3-ψ IM. The only difference is the coordinate transformation calculation.

The LPV model of IM, needed to design the observer and controller to compensate the thermally derated of an EDS, has been presented in [1], [4] and described below.

$$\{ \begin{matrix}\dot{x} = ( {\underbrace{{A}_{c} + {A}_{v} {v}_{1} + {A}_{v} {v}_{2} + {A}_{v} {v}_{3}}}_{A ( ρ )} ) x + {B}_{c} u \\ y = {C}_{c} x\end{matrix} \qquad ( 9 )$$

where A_{c}, B_{c}, C_{c} are the actual state-space matrices and Aᵥv₁, Aᵥv₂, Aᵥv₃ are the varying parameter depended matrices. The definition of these matrices are given as

$$A ( ρ ) = [ \begin{matrix}{A}_{11} ( ρ ) & 0 & {A}_{13} ( ρ ) & {A}_{14} ( ρ ) \\ 0 & {A}_{22} ( ρ ) & {A}_{23} ( ρ ) & {A}_{24} ( ρ ) \\ {A}_{31} ( ρ ) & 0 & {A}_{33} ( ρ ) & {A}_{34} ( ρ ) \\ 0 & {A}_{42} ( ρ ) & {A}_{43} ( ρ ) & {A}_{44} ( ρ )\end{matrix} ] \qquad ( 10 )$$

where

$${A}_{11} ( ρ ) = {A}_{22} ( ρ ) = - \frac{{L}_{m}^{2} {ρ}_{1} + {L}_{r}^{2} {ρ}_{2}}{σ {L}_{s} {L}_{r}^{2}} , {A}_{13} ( ρ ) = \frac{{L}_{m} {ρ}_{1}}{σ {L}_{s} {L}_{r}^{2}} \qquad ( 11 )$$

$${A}_{14} ( ρ ) = \frac{{PL}_{m} {ρ}_{3}}{2 σ {L}_{s} {L}_{r}^{2}} {A}_{23} ( ρ ) = - \frac{{PL}_{m} {ρ}_{3}}{2 σ {L}_{s} {L}_{r}^{2}} , {A}_{31} ( ρ ) = \frac{{L}_{m} {ρ}_{1}}{{L}_{r}}$$

$${A}_{24} ( ρ ) = \frac{{L}_{m} {ρ}_{1}}{σ {L}_{s} {L}_{r}^{2}} {A}_{42} ( ρ ) = \frac{{L}_{m} {ρ}_{1}}{{L}_{r}} , {A}_{33} ( ρ ) = - \frac{{ρ}_{1}}{{L}_{r}}$$

$${A}_{34} ( ρ ) = - \frac{P}{2} {ρ}_{3} , {A}_{43} ( ρ ) = \frac{P}{2} {ρ}_{3} , {A}_{44} ( ρ ) = - \frac{{ρ}_{1}}{{L}_{r}}$$

$${B}_{c} = {\frac{1}{σ {L}_{s}} [ \begin{matrix}I & O\end{matrix} ]}^{T} , {C}_{c} = [ \begin{matrix}I & O\end{matrix} ]$$

The state, time varying signal, input and output vectors of the achieved LPV model are:

$$\{ \begin{matrix}x ( t ) = {[ \begin{matrix}{i}_{α s} & {i}_{β s} & {ψ}_{α s} & {ψ}_{β s}\end{matrix} ]}^{T} , y ( t ) = {[ \begin{matrix}{i}_{α s} & {i}_{β s}\end{matrix} ]}^{T} \\ u ( t ) = {[ \begin{matrix}{v}_{α s} & {v}_{β s}\end{matrix} ]}^{T} , ρ ( t ) = {[ \begin{matrix}{R}_{r} & {R}_{s} & {ω}_{m}\end{matrix} ]}^{T}\end{matrix} , \qquad ( 12 )$$

This LPV model is validated on experimental setup in closed loop against the actual model and described in [4].

Implementations of the present disclosure include a temperature profile of high power electric machine.

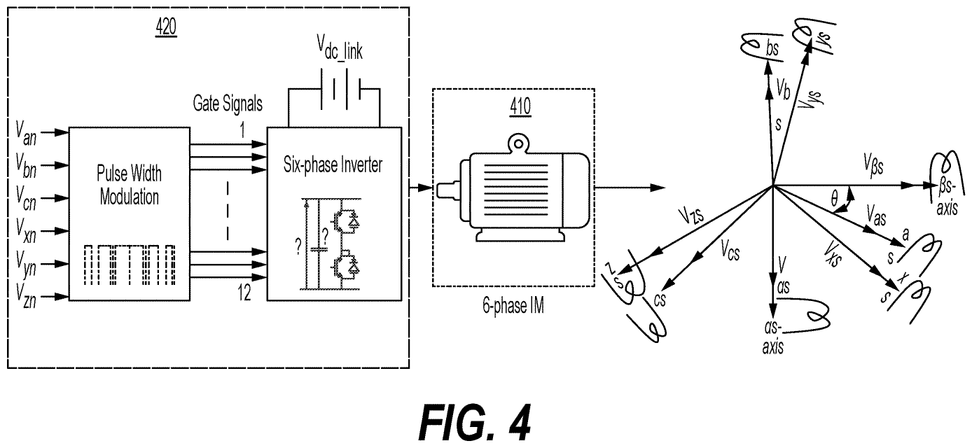

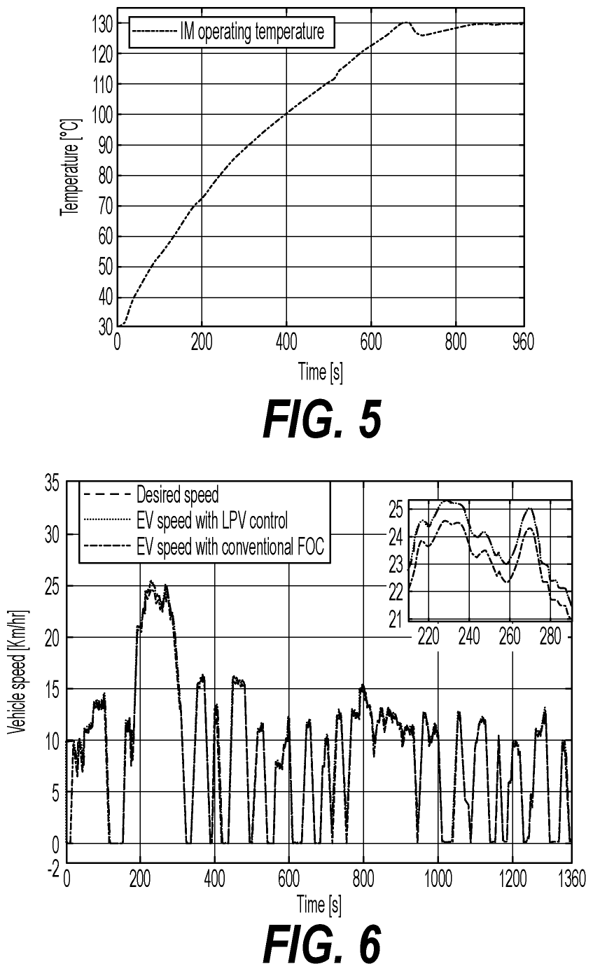

FIG. 5 shows the change in operating temperature of a high-power traction electric machine deployed in EDS of a vehicle. This change can be more for different road loads, traffic conditions, driving schedule, ambient temperature and loading. This change in the operating temperature affects the model parameters. In the present disclosure, only the rotor and stator resistance variation are considered. Due to these variations in model parameters, the torque and flux of an EDS is degraded. Hence, the performance of the conventional IFOC scheme is deteriorated. The example implementation of an LPV based IFOC scheme can address above mentioned issues in the EDS.

Implementations of the present disclosure can perform estimation of thermally derated torque and flux.

For the efficient operation of six-phase traction IM drive, the estimation of the thermally derated torque and flux can be used in the electric drive system. An LPV control technique based estimation of thermally derated torque and flux is proposed and validated in [4], [10] for three-phase traction IM drive. Hence, in the present disclosure, a LPV based torque and flux estimator can be adopted. For this purpose, induction machine model (Eqs. (4)-(8)) is changed into an LPV model as presented in (Eqs. (9)-(12)) taking Rᵣ, Rₛ and ωₘ as time varying parameters.

LPV estimators can include different types of construction, stability analysis, and error dynamics [10].

$$\{ \begin{matrix}[ \begin{matrix}{\hat{ι}}_{s} \\ \dot{\hat{ψ}}\end{matrix} ] = A ( ρ ) [ \begin{matrix}{\hat{ι}}_{s} \\ \hat{ψ}\end{matrix} ] + {B}_{c} {v}_{s} + L ( ρ ) ( {i}_{s} - {\hat{ι}}_{s} ) \\ {i}_{s} = {C}_{c} [ \begin{matrix}{i}_{s} \\ ψ\end{matrix} ] , {\hat{ι}}_{s} = {C}_{c} [ \begin{matrix}{\hat{ι}}_{s} \\ \hat{ψ}\end{matrix} ]\end{matrix} \qquad ( 13 )$$

Where, L(ρ) is the LPV oberver's gain.

The gain of the robust LPV estimator is obtained by solving Linear Matrix Inequalities (LMIs) formulated as follows:

$$\{ \begin{matrix}{A}_{i}^{T} P - {C}_{i}^{T} {Q}_{i}^{T} + {PA}_{i} - {Q}_{i} {C}_{i} ≺ 0 , i = 1 , ... , {2}^{ρ} \\ P = {P}^{T} ≻ 0\end{matrix} \qquad ( 14 )$$

Where, Aᵢ is the system matrix at each vertex.

The solution of the LMIs (Eq. (16)) can be used to find the gain at each polytope (Eq. (15)).

Lᵢ=P⁻¹Qᵢ (15)

The gain of the LPV estimator for the six-phase IM is computed as:

$$\{ \begin{matrix}L = {\sum }_{i = 1}^{i = {2}^{ρ}} {a}_{i} {L}_{i} \\ {\sum }_{i = 1}^{i = {2}^{ρ}} {a}_{i} = 1\end{matrix} \qquad ( 16 )$$

where, αᵢ(t)≥0,

The estimation of observed torque is done as

$${\hat{T}}_{e} = ( \frac{3}{2} ) P ( {\hat{ψ}}_{α s} {i}_{β s} - {\hat{ψ}}_{β s} {i}_{α s} ) \qquad ( 17 )$$

Implementations of the present disclosure include LPV based field-oriented control designs for six-phase IM.

FIG. 1A illustrates an implementation of the present disclosure including a controller 100 for a six-phase IM based EDS employed in the HEVs and EVs as described herein. The example implementation is developed based on the concept of FOC. An LPV based control strategy is developed to control and track the synchronously reference frame (d-q) currents in the inner control loop 106 based on the reference currents generated by the d-q currents controller 146, flux regulator 138 and speed regulator 136 in the outer control loop 104. In this example strategy, the thermally derated torque and flux is estimated by the LPV technique which is discussed herein. The optimal flux command can be generated by an optimal flux controller 142 by considering the IM losses and estimated torque. This can help to minimize the energy consumption and hence increase the EDS's efficiency and performance. The gains for the speed and flux regulators are obtained by formulating an LMI based on the theory of input-output feedback linearization.

Implementations of the present disclosure include designs of inner control loop 106 LPV current controllers. A practically valid, robust LPV current control (d-q currents) technique is synthesized herein for the LPV model of six-phase IM. Actuator constraints, disturbance rejection and reference tracking are the design specifications. In LPV control theory, these design specifications can be obtained by the definition of control sensitivity function (to ensure the efficient operation of EDS), complementary sensitivity function and sensitivity function (to achieve the road loads demands).

The reference d-q currents are obtained by differentiating the Eqs. (6) and (7) and it yields the following equation after simplification:

$$[ \begin{matrix}{i}_{ds}^{*} \\ {i}_{qs}^{*}\end{matrix} ] = {\frac{1}{\vert E \vert {ψ}^{2}} [ E ]}^{- 1} [ F ] \qquad ( 18 )$$

where”

$$E = [ \begin{matrix}\frac{{L}_{m} {R}_{r}}{{L}_{R}} {ψ}_{dr} & \frac{{L}_{m} {R}_{r}}{{L}_{r}} {ψ}_{qr} \\ - {n}_{p} \frac{{L}_{m}}{{L}_{r} J} {ψ}_{qr} & {n}_{p} \frac{{L}_{m}}{{L}_{r} J} {ψ}_{dr}\end{matrix} ] , F = [ \begin{matrix}ψ ( {v}_{2} + \frac{{R}_{r}}{{L}_{r}} ψ ) \\ {v}_{1} + \frac{b}{J} {ω}_{m} + \frac{1}{J} {T}_{L}\end{matrix} ]$$

In LPV control, the gains of the weighting filters are tuned until (i) stability of the plant, (ii) disturbance and noise rejection with fast tracking, and (iii) constraints on the control actuator, are achieved. The objective is to compute the output feedback LPV control which maximizes the performance of EDS in the presence of vast variations in operating temperature. The dynamic LPV controller can be represented as

$$\{ \begin{matrix}{\dot{x}}_{K} = {A}_{K} ( ρ ) {x}_{K} + {B}_{K} ( ρ ) y \\ u = {C}_{K} ( ρ ) {x}_{K} + {D}_{K} ( ρ ) y\end{matrix} \qquad ( 19 )$$

which ensures the L₂ gain bound and internal stability of the closed-loop system. The design methodology and steps for the LPV current controller are outlined in [4].

Implementations of the present disclosure include designs of outer loop flux and speed regulators.

The outer loop flux and speed regulators are designed for the proposed LPV based FOC strategy using the concept of Robust Input-Output Linearization (RIOL). The model parameters uncertainties are taken into account in the process of computing the robust gains for the outer loop regulators. The closed-loop error dynamics for the model described in Section II are constructed using the stator currents (i_{ds}, i_{qs}), the rotor flux and the speed (ψ,ωₘ) are considered as input and output vectors respectively. The definition of bounded real lemma [12] is deployed to achieve the LMI from the developed error dynamics as given in Eq. (20).

$$[ \begin{matrix}{H}^{T} + H & {PB}_{e} & {I}_{2} \\ {B}_{e}^{T} P & - γ {I}_{2} & 0 \\ {I}_{2} & 0 & - γ {I}_{2}\end{matrix} ] ≺ 0 \qquad ( 20 )$$

where, P=P^{T}>0 and γ>0.

The solution of Eq. (20) gives the H and P. From these, the gains of the speed and flux regulators can be obtained as:

Gₑ=P⁻¹H (21)
Where, Gₑ is the diagonal gain matrix.

Implementations of the present disclosure include optimal flux calculations. The six-phase IM for an EDS operates at different speed and torque over the entire driving cycle. In order to minimize the energy consumption during the operation, it is not a good practice to operate the EDS at rated flux. Hence, electric machine's losses are considered to compute the optimal flux command to obtain the high efficiency of EDS. The three main losses in IM can be described as:

The stator losses:

$${P}_{s} = \frac{3}{2} {R}_{s} ( {i}_{ds}^{2} + {i}_{qs}^{2} ) \qquad ( 22 )$$

The rotor losses:

$${P}_{r} = \frac{3}{2} {{R}_{r} ( \frac{{L}_{m}}{{L}_{r}} )}^{2} {i}_{qs}^{2} \qquad ( 23 )$$

The stator iron losses:

$${P}_{i} = \frac{1}{{R}_{c} {ω}_{c}^{2}} ( {L}_{m}^{2} {i}_{ds}^{2} + {( {L}_{m}^{2} - \frac{{L}_{m} {L}_{r}}{{L}_{s}} )}^{2} {i}_{qs}^{2} ) \qquad ( 24 )$$

The total steady state losses are given as:

Pₗₒₛₛ=Pₛ+Pᵣ+Pᵢ (25)

Putting the steady state values of the i_{ds}, i_{qs} and ωₑ and minimizing the Eq. (25), optimal flux trajectory can be computed as:

$$\{ \begin{matrix}{ψ}_{ref} = {ψ}_{opt} \sqrt{\vert {T}_{{e}_{ref}} \vert} \\ ψ = {k ( \frac{( {R}_{s} + {ω}_{e}^{2} {L}_{m}^{2} )}{( {R}_{s} + ( \frac{{R}_{r} {L}_{m}^{2}}{{L}_{r}^{2}} ) + ( \frac{( {{ω}_{e}^{2} ( {L}_{m}^{2} - {L}_{s} {L}_{r}^{2} )}^{2} )}{( {R}_{c} {L}_{r}^{2} )} ) )} )}^{1 / 2}\end{matrix} \qquad ( 26 )$$

where

$$k = \frac{4}{3} \frac{{L}_{m}}{P}$$

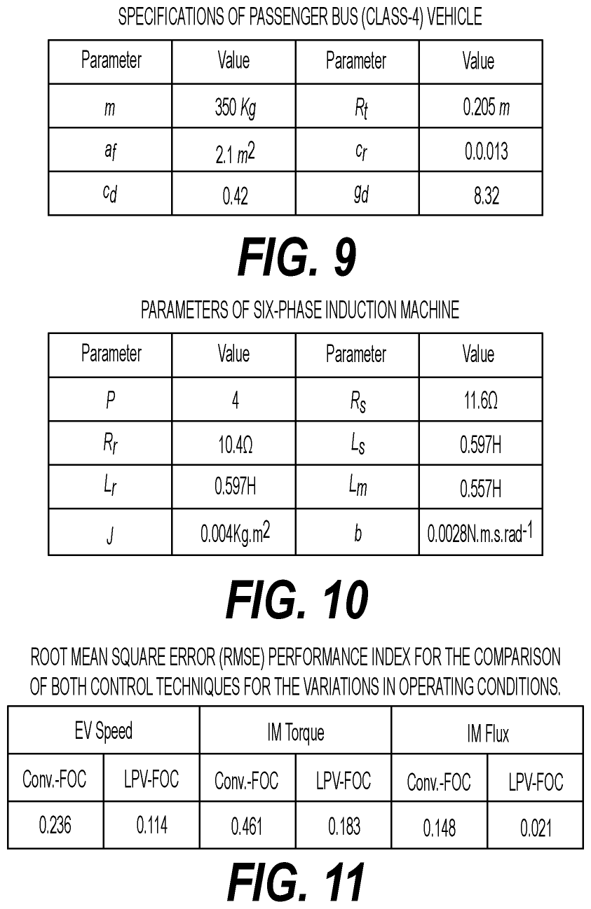

The study included simulation experiments. In order to validate the efficacy and performance of the example LPV based IFOC scheme, simulation experiments were performed on the high fidelity EV simulator developed in MATLAB/SIMULINK as commonly exercised by automotive community to evaluate their control frameworks. FIG. 9 illustrates the parameters values for the passenger bus (class-4) vehicle and FIG. 10 illustrates the parameter values for the six-phase induction that are adopted in the example study. The evaluation is performed under the variation of different operating conditions such as variations in operating and ambient temperatures, change in stator and rotor resistances and change in the load. Federal Urban Driving Schedule (FUDS) is adopted to show the efficacy of the proposed control scheme. To obtain the best possible performance, the observer-controller pair can be designed as described herein.

FIG. 6 depicts the tracking performance of vehicle speed. It is vivid that the proposed LPV based IFOC scheme shows the better performance in the presence of vast variations in operating and ambient temperature (in result, variations in rotor and stator resistances of IM). The performance of conventional IFOC is also presented under the same operating conditions in FIG. 6. It is signified from the FIG. 6 that LPV based IFOC scheme achieved the better tracking performance of vehicle speed as compared to conventional IFOC. The performance of conventional IFOC at higher operating temperature (higher change in rotor and stator resistance) is degraded more as compare to proposed scheme. In this context, the tracking performance for the demanded torque and flux can be determined and analyzed further.

FIG. 8 shows the torque tracking of both control scheme for the comparison over the entire driving cycle. The LPV based IFOC sheme shows better torque tracking performance in the presence of variations in model parameters. As a result, the proposed control scheme encompasses the rapid changes (due to traffic conditions for a particular route) in the demanded torque well as compared to convention control scheme. Hence, smooth operation of the vehicle is guaranteed.

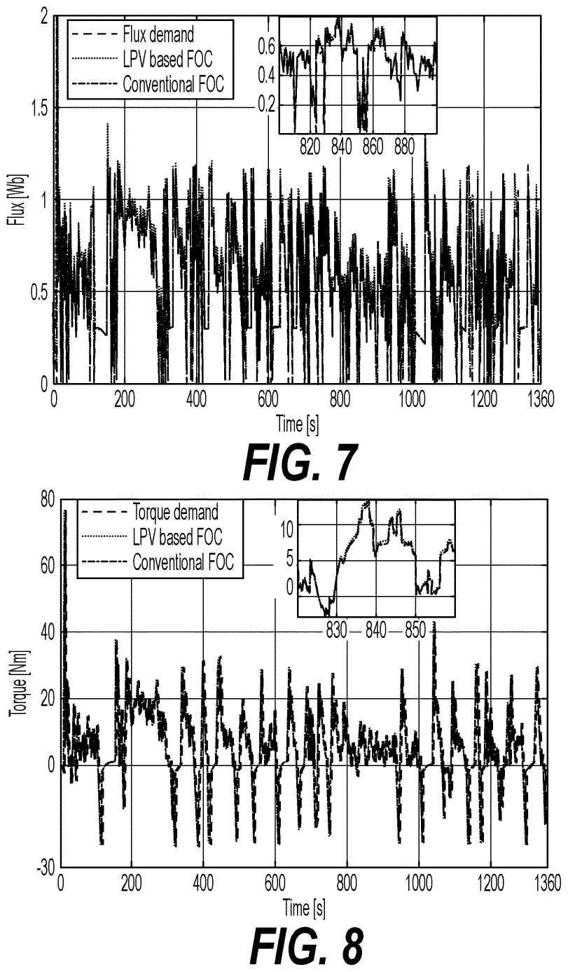

In order to achieve the higher efficiency of the EDS, IM is required to follow the commanded flux over the entire operation. FIG. 7 presents the flux tracking of the six-phase IM for the conventional IFOC and proposed LPV based IFOC schemes.

The Root Mean Square Error (RMSE) value in EV speed, IM flux and torque is used as a performance metric. FIG. 11 illustrates the RMSE tracking errors.

In sum, the study shows that the example implementation includes a robust LPV based IFOC technique to achieve the optimal performance of multiphase induction machine electric drive system. Its was is tested for an EV's powertrain operated in FUDS driving cycle with a dynamic temperature profile. The comparison of the proposed technique was carried out with conventional IFOC. The example LPV based IFOC scheme is more robust to change in operating and ambient temperatures and in turns to R_{S} and Rᵣ variations as well.

Optionally, implementations of the present disclosure can including measuring the efficacy of the proposed observer controller pair on Hardware-in-Loop (HIL) test setup, and/or (ii) quantify the effect of proposed control scheme with respect to efficiency and aging of the EDS.

### Example 2

A study was performed of an example implementation of the present disclosure. The example implementation is configured to control multiphase induction machines. Example benefits of a multiphase induction machine over three-phase equivalents are: (1) Power rating requirements of the power semiconductor devices on the converter can be reduced; (2) Regardless of the number of phases, two independent controllable currents are required for flux and torque control; (3) Low pulsating torque due to the use of a multi-step inverter; (4) Smaller rated current per phase; (5) better reliability; and/or (6) Ability to operate in case of open phase fault.

An example architecture of six-phase IM is shown in FIG. 4. The example architecture can have an angular separation of 30° between two sets of 3-phase winding

Optionally, the example in FIG. 4 gives the two isolated neutral points which can (1) Ensure optimized use of dc link voltage, (2) Eliminate zero sequence currents

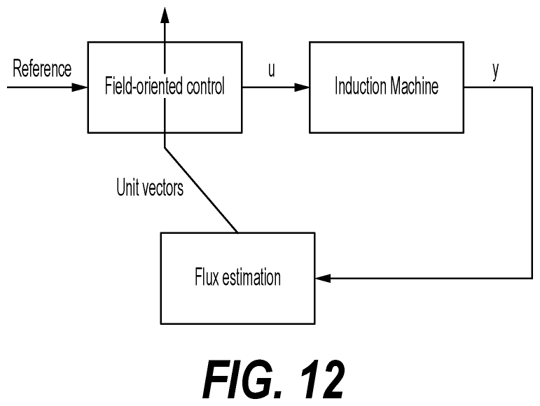

The study shows that a synthesis of LPV based FOC scheme for multiphase induction machine can have significantly better performance than the conventional FOC when efficacy is tested for EVE powertrains operated in FUDS driving cycle with a dynamic temperature profile. An example field-oriented control framework is illustrated in FIG. 12

### Example 3

### Dynamic Drive Control Scheme for Energy-Efficient Electric Drive Systems

The automotive, aerospace/defense, rail, marine, and manufacturing industries are rolling out energy-efficient electrified powertrains due to an increase in energy needs against inadequate energy resources. One of the integral parts of an electrified powertrain is the traction multiphase Electric Machine (EM), which impacts the performance and cost of the vehicle. The performance of an Electric Drive System (EDS) in extreme working conditions suffers from torque derating, a decrease in efficiency, and an increase in loss of lifetime (aging) as its parameters change due to the change in operating and ambient temperatures.

The study included developing a learning-based control algorithm and produce the software for electric powertrains used in electrified aircraft, and electric and hybrid vehicles to address the problem of a decrease in efficiency, aging, flux, and torque derating due to the change in operating and surrounding temperatures of an electrified powertrain. Another main purpose of the proposed dynamic drive algorithm is to ensure the fault-tolerant and efficient operation of the electric drive over a vast operating range.

The efficacy of the proposed control algorithm was evaluated for the EDS when operating under different road loads, operating, and surrounding temperatures. This algorithm will make the EDS immune to performance degradation, rapid aging, and poor efficiency. This technology/product will be completely a software-based solution, and any automotive and aerospace industry can install it on their Electronic Control Units (ECUs) and Vehicle Control Units (VCUs) to get the benefits. In some implementations, no hardware changes are required.

To address the crucial issue of electric machine performance degradation due to the harsh environment and operating conditions, the present disclosure includes a design developed based on the dynamic drive control. The Dynamic Drive Control Scheme (DDCS) facilitates the control of multiphase EM to overcome the problem of thermally derated torque, minimizing the loss of lifetime (aging), and improving the energy conversion efficiency of the multiphase EM. A dynamic control scheme allows the controller to schedule (re-compute) itself based on the changes observed in the parameters of the EDS to address the issue of thermally derated torque. It can utilize the machine's losses to compute the optimal flux demand to ensure improvements in the energy conversion efficiency of the EM and develop a dynamic relationship between road load demands and flux. The optimal cost function is formulated based on the operating voltages and currents' constraints to minimize aging. This proposal is composed of a systematic application of knowledge toward the design, development, and hardware realization of the prototype.

Implementations of the present disclosure can be employed almost in all the large-scale industries of the world which includes but not limited to automotive, aerospace/defense, rail, marine, and manufacturing industries which need to enhance their overall product life (aging) and its efficiency approximately. The example implementations of the present disclosure include a learning-based (self-learning) control algorithm which is an essential component used in the above-mentioned industries. The implementation of this technology will make the system immune to performance degradation, rapid aging, and poor efficiency.

The automotive, aerospace/defense, rail, marine, and manufacturing industries all can face the problems of thermally derated torque, efficiency reduction, and aging in the existing EDS technology. Manual calibration can be difficult in industrial and transportation settings, and a self-learning algorithm can be used to overcome those challenges. The development and design of a dynamic control (intelligent control) technique (such as DDCS technology in the current proposal), can be beneficial.

Implementations of the present disclosure can further reduce energy usage and greenhouse gasses emitted to the environment by improving the efficiency of the electric drive system for modern vehicles.

In an electrified powertrain, an EM can be used to meet the loads at different speeds in all operating conditions. However, due to part load operations and variations in operating and surrounding temperatures, the EM parameters change. As a result, the torque-delivering capability of the EM derates [1B,2B], unlike an industrial drive, which operates at constant loads and temperatures. Under these conditions, the EM must supply the desired torque requested by the driver, thus forcing the EM to operate in inefficient regions. Similarly, the aging of the EM is accelerated by several stress factors, which include high ambient temperatures, variation in vehicle duty cycle, and changes in payloads. These stress factors will create voltage and current imbalance and increase winding temperatures during the EM operation for an electrified powertrain, unlike an industrial drive [3B]. This can result in a loss of flux generation capability of the windings, thus affecting the torque-producing capability of the electric machine. Conventional control technique used for torque and flux control of the EM can be sensitive to all the above-mentioned changes in the EDS during the operation. The robust estimation technique according to implementations of the present disclosure can be used to estimate the derated torque so that the overall performance of the EDS can be improved [4B]. Similarly, efficient control techniques are designed and developed can manage the thermally derated torque, efficiency, and aging of the EDS [3B,5B]. These estimation and control techniques can be used in implementations of the present disclosure for DDCS for energy-efficient EDS. Thus, implementations of the present disclosure can include learning-based controller/software which will tune itself to extract better performance, minimizing the aging and improving efficiency for an electrified powertrain used in modern electric on-road, off-road, and aerial vehicles.

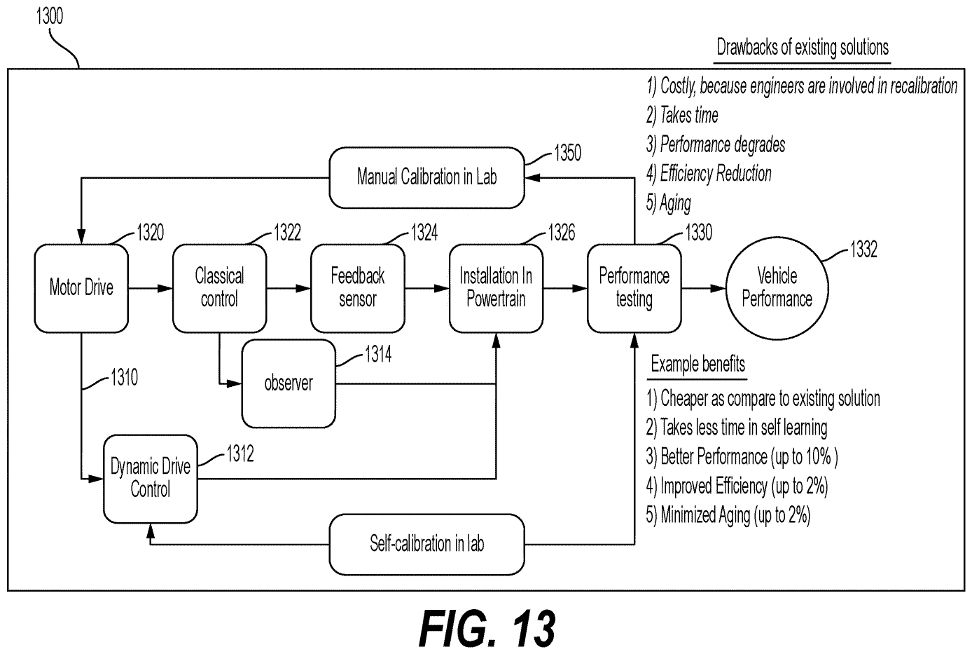

The block diagram shown in FIG. 13 shows a block diagram 1300 comparing a control loop 1310 according to an implementation of the present disclosure with a conventional control loop 1350. The control loop 1310 includes a controller 1312 according to an implementation of the present disclosure, referred to herein as “dynamic drive control.” The control loop 1310 can further include an observer 1314.

As shown in FIG. 13, the controller 1312 can be incorporated into a system with a motor drive 1320, classical control block 1322, one or more feedback sensor(s) 1324, and a powertrain 1326. The present disclosure also contemplates that the controller 1312 can be tested with a test stage 1330 to output vehicle performance information 1332.

The conventional control loop 1350 can require additional manual calibration that can be costly and expensive. As time goes on, the performance of the conventional control loop 1350 can degrade, with reduced efficiency and aging.

The control loop 1310 can be cheaper and quicker to calibrate than the conventional control loop 1350. Implementations of the present disclosure can further include increased performance (e.g, 10% increased performance), improved efficiency (e.g., 2% improved efficiency) and/or reduced aging (e.g., 2% reduction in aging).

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
[1] Hanif, A., Ahmed, Q., Bhatti, A. I. and Rizzoni, G., 2020. A Unified Control Framework for Traction Machine Drive Using Linear Parameters Varying-Based Field-Oriented Control. Journal of Dynamic Systems, Measurement, and Control, 142(10).
[2] Libbos, E., Ku, B., Agrawal, S., Tungare, S., Banerjee, A. and Krein, P. T., 2020. Loss minimization and maximum torque-per-ampere operation for variable-pole induction machines. IEEE Transactions on Transportation Electrification, 6(3), pp. 1051-1064.
[3] Levi, E., Barrero, F. and Duran, M. J., 2015. Multiphase machines and drives-Revisited. IEEE Transactions on Industrial Electronics, 63(1), pp. 429-432.
[4] Hanif, A., Bhatti, A. I. and Ahmed, Q., 2017. Managing thermally derated torque of an electrified powertrain through LPV control. IEEE/ASME Transactions on Mechatronics, 23(1), pp. 364-376.
[5] Levi, E., Bojoi, R., Profumo, F., Toliyat, H. A. and Williamson, S., 2007. Multiphase induction motor drives-a technology status review. IET Electric Power Applications, 1(4), pp. 489-516.
[6] Morawiec, M., Strankowski, P., Lewicki, A., Guziński, J. and Wilczyński, F., 2019. Feedback control of multiphase induction machines with backstepping technique. IEEE Transactions on Industrial Electronics, 67(6), pp. 4305-4314.
[7] Singh, G. K., Nam, K. and Lim, S. K., 2005. A simple indirect fieldoriented control scheme for multiphase induction machine. IEEE Transactions on Industrial Electronics, 52(4), pp. 1177-1184.
[8] Holakooie, M. H. and Iwanski, G., 2020. An adaptive identification of rotor time constant for speed-sensorless induction motor drives: A case study for six-phase induction machine. IEEE Journal of Emerging and Selected Topics in Power Electronics, 9(5), pp. 5452-5464.
[9] Fnaiech, M. A., Betin, F., Capolino, G. A. and Fnaiech, F., 2009. Fuzzy logic and sliding-mode controls applied to six-phase induction machine with open phases. IEEE Transactions on Industrial Electronics, 57(1), pp. 354-364. Hanif, A., Bhatti, A. I. and Ahmed, Q., 2016 July. Estimation of thermally de-rated torque of an HEV drive using robust LPV observer. In 2016 American Control Conference (ACC) (pp. 1530-1535). IEEE.
[10] Kommuri, S. K., Defoort, M., Karimi, H. R. and Veluvolu, K. C., 2016. A robust observer-based sensor fault-tolerant control for PMSM in electric vehicles. IEEE Transactions on Industrial Electronics, 63(12), pp 76717681.
[11] Werner, H., 2007. Optimal and robust control. Lecture Notes, Ins. Control Systems, Hamburg Univ. Technology.
[1B] Reyes, J. R. M. D., Parsons, R. V., & Hoemsen, R. (2016). Winter happens: The effect of ambient temperature on the travel range of electric vehicles. IEEE Transactions on Vehicular Technology, 65(6), 4016-4022.
[2B] Hanif, A., Bhatti, A. I. and Ahmed, Q., 2017. Managing thermally derated torque of an electrified powertrain through LPV control. IEEE/ASME Transactions on Mechatronics, 23(1), pp. 364-376.
[3B] Hanif, A., Ahmed, Q., Bhatti, A. I. and Rizzoni, G., 2020. A unified control framework for traction machine drive using linear parameters varying-based field-oriented control. Journal of Dynamic Systems, Measurement, and Control, 142(10).
[4B] Hanif, A., Bhatti, A. I. and Ahmed, Q., 2016 July. Estimation of thermally de-rated torque of an HEV drive using robust LPV observer. In 2016 American Control Conference (ACC) (pp. 1530-1535). IEEE.
[5B] Safder, A. H., Hanif, A., Saqib, M. A., & Tanveer, F. (2023 March). Compensating the Performance of PMSM-Based Electrified Powertrain Through Sliding Mode Control. In 2023 IEEE Applied Power Electronics Conference and Exposition (APEC) (pp. 2413-2418). IEEE.

1. A method for controlling a multiphase electric machine, comprising:
providing a control system operably connected to the multiphase electric machine;
receiving, using the control system, a plurality of inputs, wherein the plurality of inputs represent a state of the multiphase electric machine;
performing, using the control system, a linear parameters varying (LPV) based field oriented control (FOC) based on the plurality of inputs to generate one or more control signals; and
controlling, using the control system, the multiphase electric machine based on the one or more control signals.

2. The method of claim 1, wherein performing, using the control system, the LPV based FOC comprises estimating a thermally derated torque of the multiphase electric machine.

3. The method of claim 1, wherein performing, using the control system, the LPV based FOC comprises estimating a thermally derated flux of the multiphase electric machine.

4. The method of any one of claim 1, wherein the multiphase electric machine is a six-phase induction motor.

5. The method of any one of claim 1, wherein the control system comprises:
an outer control loop comprising flux and speed regulators, the outer control loop being configured to generate reference currents for the multiphase electric machine, and
an inner control loop comprising a (d-q) currents controller, the inner control loop being configured to control and track frame currents (i_{d} and i_{q}) based on the reference currents generated by the outer control loop.

6. The method of claim 5, further comprising determining a constant current for the multiphase electric machine using the outer control loop.

7. The method of claim 5, wherein the outer control loop comprises a speed regulator, and the method further comprises determining a variable gain of the speed regulator.

8. The method of claim 5, wherein the outer control loop comprises a flux regulator, and the method further comprises determining a variable gain of the flux regulator.

9. The method of claim 1, wherein the one or more control signals for controlling the multiphase electric machine comprise voltage signals.

10. A controller comprising:
an outer control loop comprising a flux regulator and a speed regulator, the outer control loop being configured to:
receive a plurality of inputs, wherein the plurality of inputs represent a state of a multiphase electric machine, and
generate a plurality of reference currents for the multiphase electric machine; and
an inner control loop comprising a (d-q) currents controller, the inner control loop being configured to:
control and track frame (d-q) currents based on the reference currents generated by the outer control loop, and generate a feedback signal based on the frame currents (i_{d} and i_{q}), wherein the outer control loop is further configured to receive the feedback signal generated by the inner control loop and generate one or more control signals for controlling the multiphase electric machine.

11. The controller of claim 10, wherein outer loop further comprises an optimal flux controller.

12. The controller of claim 10, wherein the outer control loop further comprises a variable-gain speed regulator.

13. The controller of claim 10, wherein the outer control loop further comprises a variable-gain flux regulator.

14. The controller of claim 10, wherein the inner control loop is configured to maintain a constant current input to the multiphase electric machine.

15. The controller of claim 10, wherein the one or more control signals comprise voltage signals.

16. A system comprising:
a multiphase electric machine; and
a controller operably coupled to the multiphase electric machine, the controller being configured to control the multiphase electrical machine, the controller comprising:
an outer control loop comprising a flux regulator and a speed regulator, the outer control loop being configured to:
receive a plurality of inputs, wherein the plurality of inputs represent a state of the multiphase electric machine, and
generate a plurality of reference currents for the multiphase electric machine; and
an inner control loop comprising a (d-q) currents controller, the inner control loop being configured to:
control and track frame currents (i_{d} and i_{q}) based on the reference currents generated by the outer control loop, and generate a feedback signal based on the frame currents (i_{d} and i_{q}), wherein the outer control loop is further configured to receive the feedback signal generated by the inner control loop and generate one or more control signals for controlling the multiphase electric machine.

17. The system of claim 16, wherein the outer control loop further comprises an optimal flux controller.

18. The system of claim 16, wherein the speed regulator is a variable-gain speed regulator.

19. The system of claim 16, wherein the flux regulator is a variable-gain flux regulator.

20. The system of claim 16, wherein the inner control loop is configured to maintain a constant current input to the multiphase electric machine.

21. (canceled)

22. (canceled)

23. (canceled)
